(19) United States
(12) Patent Application Publication
(10) Pub. No.: US 2015/0379635 A1
(43) Pub. Date: Dec. 31, 2015

(54) AN ELECTRONIC MINERAL RESERVE VALUATION METHOD AND A SYSTEM THEREFOR

(71) Applicant: PUREPLAY HOLDINGS (PROPRIETARY) LIMITED, Durban (ZA)

(72) Inventor: Sarel Johannes OBERHOLSTER, Ruimsig, Roodepoort (ZA)

(21) Appl. No.: 14/769,172

(22) PCT Filed: Feb. 10, 2014
(86) PCT No.: PCT/IB14/58876

§ 371 Date: Aug. 20, 2015

(30) Foreign Application Priority Data
Feb. 22, 2013 (ZA) 2013/01386
Jul. 8, 2013 (ZA) 2013/05109

(51) Int. Cl. G06Q 40/04

(52) U.S. Cl. CPC G06Q 40/04

(57) ABSTRACT

A method and system for implementing an electronic mineral reserve valuation is provided. The system includes a communications module for receiving an electronic request message from a purchaser to purchase a quantity of mineral, at a current spot price for the mineral. The quantity of mineral is currently stored in its natural environment in or on the Earth's crust prior to it being extracted. The request includes that the quantity of mineral is to be made available to the purchaser at a future specified time. A memory for storing relevant data and an issuing module then issues the purchaser with a unique electronic certificate including at least the quantity of mineral, agreed specifications and the future specified time.

### BACKGROUND OF THE INVENTION

The present application relates to an electronic mineral reserve valuation method and a system therefor,

For many years the International Accounting Standards Board has obliged owners of mineral reserves to classify those reserves as intangible and to value them at the cost of finding specific mineral reserves without reference to their market value.

The present invention provides a method and system for mineral reserve valuation which enables the owner of the mineral reserve to value its mineral reserves as a tangible asset in terms of a market-related formula.

### SUMMARY OF THE INVENTION

According to one example embodiment, a system for implementing an electronic mineral reserve valuation, the system including:
a communications module for receiving an electronic request message from a purchaser to purchase a quantity of mineral, at a current spot price for the mineral, the quantity of mineral being currently stored in its natural environment in or on the Earth's crust and prior to it being extracted, the quantity of mineral, to agreed specifications, to be made available to the purchaser at a future specified time;
a memory for storing the identity of the purchaser, the price, the quantity of mineral, the agreed specifications and the future specified time; and
an issuing module for issuing the purchaser with a unique electronic certificate including at least the quantity of mineral, the agreed specifications and the future specified time.

The communications module may receive requests from a plurality of users and issues unique electronic certificates to each of the plurality of users.

The system may also include a value allocating module for allocating a value to a quantity of mineral that is not yet extracted and storing the allocated value and quantity of mineral in a memory, wherein the value allocating module uses a current spot price for the mineral together with a selected extraction cost to allocate a value for the electronic certificates and to thereby assign a value to a body of mineral reserves currently stored in its natural environment in or on the crust of the Earth.

The value allocating module may draw or accept inputs of the selected extraction cost from a miner's own calculations, current at the time that the value of the reserves is being calculated, of the cost of extracting various portions of the reserve, depending on the ore concentrations, accessibility and other relevant factors relating to the portion.

In one example, the value allocating module selects the extraction cost and a desired profit that together do not exceed the spot price.

According to another example embodiment, an electronic mineral reserve valuation method includes:
receiving an electronic request message from a purchaser to purchase a quantity of mineral, to stated specifications, at or slightly above or below, the current spot price for the mineral, the quantity of mineral being currently stored in its natural environment, in or on the crust of the Earth, the quantity of mineral to be made available to the purchaser at a future specified time;
storing the identity of the purchaser, the price, the quantity of mineral, the specifications and the future specified time; and
issuing the purchaser with a unique electronic certificate including at least the quantity of mineral, the specifications and the future specified time.

Requests may be received from a plurality of users and unique electronic certificates are issued to each of the plurality of users.

The method may further include allocating a value to a quantity of mineral that is not yet extracted, and storing the allocated value and quantity of mineral in a memory, wherein a current spot price for the mineral is used together with a selected extraction cost to allocate a value for the electronic certificates and to thereby assign a value to a body of mineral reserves currently stored in its natural environment.

The selected extraction cost may be drawn from a miner's own calculations, current at the time that the value of the reserves is being calculated, of the cost of extracting various portions of the reserve, depending on the ore concentrations, accessibility and other relevant factors relating to the portion.

In one example, the extraction cost, plus a desired profit, is selected so that it does not exceed the spot price.

### BRIEF DESCRIPTION OF THE DRAWINGS

FIG. 1 is a block diagram illustrating an example server in more detail; and

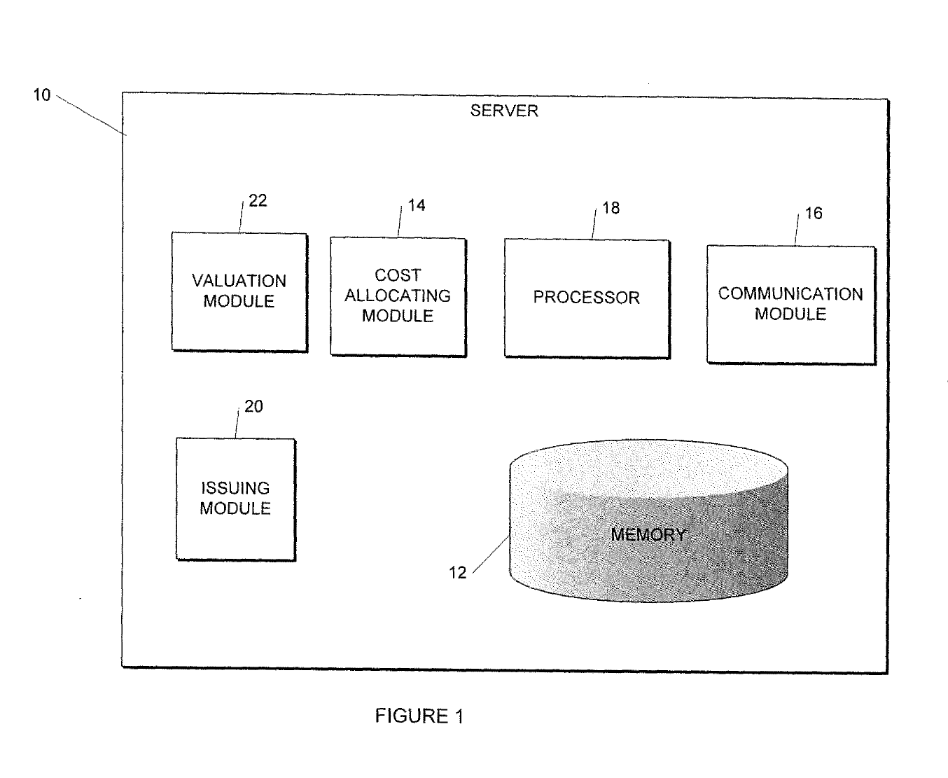

FIG. 2 is a flow chart illustrating the methodology of an example embodiment.

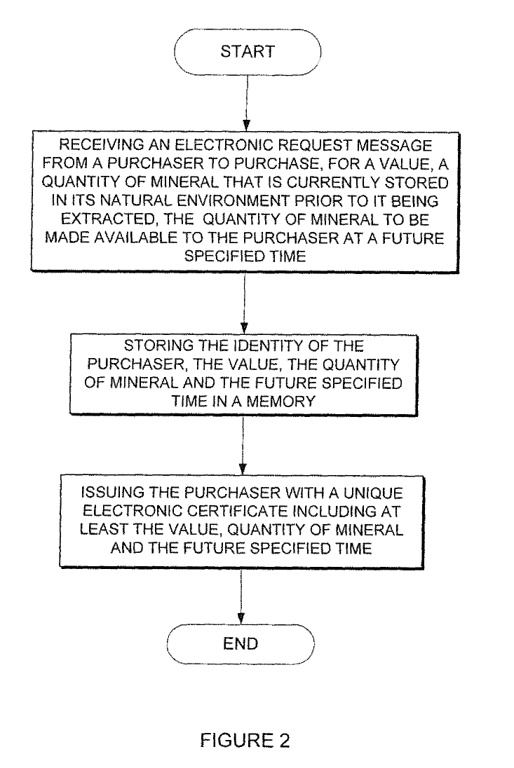

### DESCRIPTION OF EMBODIMENTS

The systems and methodology described herein relate to a method of implementing an electronic mineral reserve valuation.

For the purpose of the present application:

(a) “extracted” means extracted, either fully or partially, from its natural environment, and/or refined, and/or processed, and in each case delivered, and “extract”, extracting”, “extractable” and “extraction” have corresponding meanings. For example, in respect of iron ore, the iron ore dug up, very crudely refined to the point where it is still largely embedded in its original surrounding rock and is only 62% pure, and then sold in that form, has been partially extracted, partially refined and then delivered. In addition there are grades of specifications for all minerals, so that for example with gold it is sometimes refined to one level and sometimes to another. In all cases, in accordance with South African legal principles, there must eventually be “delivery” in order to pass ownership to the holder of the Instrument. It will be appreciated that for purposes of this patent specification the term “extracted” covers all of these scenarios.

(b) “on the Earth's crust” in respect of a mineral means naturally occurring on the surface of the Earth's crust or removed from its natural environment in the Earth's crust and stockpiled on the surface of the Earth still embedded in the material in which it was found and with little value added to it;

(c) a “mineral reserve” means a concentration or occurrence of fungible material of intrinsic economic interest in or on the Earth's crust in such form, quality and quantity, verified to an extent by investigation, that there are prospects for eventual economic extraction, and “mineral” and “reserve” have the same meaning as in “mineral reserves”.

Referring to the accompanying Figures, an electronic mineral reserve valuation system includes a server 10 that includes a number of modules to implement the present invention and an associated memory 12.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules may form a physical apparatus with physical modules specifically for executing the steps of the method described herein.

A value allocation module 14 allocates a value to a quantity of mineral that is currently stored in its natural environment in or on the Earth's crust and prior to it being extracted, and stores the allocated value and quantity of mineral in the memory 12.

For purposes of illustration, the mineral reserve will be described herein as gold. However, it will be appreciated that the system and methodology described can be equally applied to any other pre-existing fungible mineral reserve.

In any event, an example of calculating a value for the quantity of mineral is described with reference to one ounce of gold and the spot market. It will be appreciated that in certain circumstances, by structuring the safe transaction, many of the same principles could apply to a market which is not a spot market.

That value is equal to the spot market price of an ounce of gold minus a selected cost of extraction. The selected cost is drawn from the miner's own calculations, current at the time that the value of the reserves is being calculated, of the cost of extracting various portions of the reserve, depending on the ore concentrations, accessibility and other relevant factors relating to the portion. No present value can be attributed to any portion of the reserves where the selected cost exceeds the spot price of that quantity of gold at the date of the calculation of the value of the reserves. Since different selected costs apply to different portions of the reserves, the value of the economically viable part of the reserves as a whole is equal to the spot price at the time for the total quantity that can be extracted at those selected cost prices, minus the aggregate of those selected costs for that quantity.

The selected extraction cost component will be specific to a mineral owner and to a mineral reserve body or part of it and will be known or can be established at any given point in time.

Thus in the illustrative example, a value is allocated to an ounce of gold using the above methodology.

A body of gold-containing ore is measured and indicated to determine the amount of reserves, their position, accessibility and concentration.

Typically, the rights to mine the body of gold ore will belong to a particular owner who is therefore the de facto owner of the gold whilst it is still stored in its natural environment prior to it being extracted. The owner will know how many ounces of gold are located in the reserve.

However, these mineral reserves are not homogenous, as the ore content of one part of the reserve may be more inaccessible than that of another part. Ore concentrations may differ from one part of the reserve to another. The ore content or location or accessibility of some part may be too low to extract at current mining costs.

The selected extraction cost referred to above is therefore a starting point. The mines have the ability to tailor their operations to achieve almost whatever extraction cost they wish, within reason. At that selected extraction cost only a portion of the reserves can be mined economically viably. As the given selected extraction cost increases, so additional proportions of the reserves can be mined.

A simplified illustrative example of the above may be as follows. A mine may have three pockets of gold ore, one requiring an extraction cost of USD500 per ounce, a second deeper pocket requiring an extraction cost of USD700 per ounce and a third even deeper requiring an extraction cost of USD1,400 per ounce, Each pocket may also have a different concentration of ore, which has a bearing on the extraction cost.

With the spot price of gold being at USD1,200 per ounce it will be appreciated that only pockets 1 and 2 can be economically viably mined.

Thus the miner will only value pockets 1 and 2 as economically viable.

If the spot gold price per ounce had to rise to USD1,500 per ounce, pocket 3 could now also be economically viably mined albeit at a lower profit margin. The miner may now value pocket 3 as economically viable.

The mines have the information available on what parts of their reserves can be mined for what extraction costs. At a certain point the increase in extraction costs ceases to result in any significant increase in the quantity of the reserves that can be extracted. This point is then the maximum cost for the mine at that point in time, given the profit which it decides it needs to make per unit of mineral. Extracting the mineral at greater cost than that cost would imply extracting the mineral at a loss, or at a lower than acceptable profit, Thus it will be appreciated that if spending more money in extraction does not result in greater profitability, then the maximum cost level has been passed. The maximum cost is that last marginal unit of cost incurred at which ore can still be extracted at a profit; the very next unit of cost incurred to extract ore will either be at breakeven, a loss or a lower than acceptable profit.

Those combined levels of selected cost, to a maximum of the spot price of the commodity, are then what are used in the calculation of the value of the reserves which are economically viable at that point in time.

The remaining reserves are of course not valueless—they simply have no precisely ascertainable present economically extractable value, but may or may not nevertheless have a future market value and may or may not nevertheless have a present market value.

In any event, the owner will then typically offer for sale so many ounces of gold stored in its natural environment prior to it being extracted at a value. The owner will typically combine the offer to sell gold stored in its natural environment prior to it being extracted with an obligation to extract or have extracted, that gold, the quantity of gold to be made available to the purchaser at a future specified time and to make the quantity of gold available according to a pre-agreed specification.

The server 10, via communication module 16 receives an electronic request message from a purchaser to purchase, for a value, a quantity of mineral that is currently stored in its natural environment in or on the Earth's crust and prior to it being extracted, and as part of the extraction process to be refined to agreed specifications, and to be delivered to the purchaser at a future specified time

For example, the purchaser may indicate that it is willing to offer $100 per ounce, and that the purchaser would like to buy two ounces of gold to agreed specifications to be delivered to the purchaser in 10 years' time.

Processor 18 then checks to see if the offered price is acceptable to the owner according to pre-established value parameters, and if so whether two ounces of gold are available for sale based on the reserve and the amount of ounces already sold, and, if the price is acceptable and the gold is available, allocates two ounces of gold to the purchaser.

This is stored in memory 12 together with the identity of the purchaser, the value, the quantity of mineral, the agreed specifications and the future specified time.

The processor 18 keeps track of the quantity of reserve available for sale and reduces this by the two ounces sold to the purchaser.

The method may include receiving requests from a plurality of users and issuing unique electronic certificates to each of the users.

In one example, the reserve will be sold in tranches at appropriate intervals so that the price achieved is averaged through cycles in the ruling market price, and the cost of redeeming a tranche by delivering the gold which is the subject of that tranche is averaged through cycles in the extraction cost of the mineral. Each tranche will endure for more or less the same period, but the staggered issue is designed to cause staggered redemption.

The sale in tranches avoids clumped redemption and concentrated price risk, which could be detrimental to the owner. Applying this principle of averaging the selling price and the potential opportunity cost associated with market price movements of the mineral at redemptions over multiple tranches is an enhancement to the utilisation methodology.

The use of staggered sales does not in any way prevent or eliminate the use of single or multiple sales with concentrated price and redemption risks where appropriate for an issuer, or a combination of staggered and concentrated sales.

The purchaser will pay the price of the two ounces in an appropriate manner.

This may be paid in money, in the physical mineral which is the subject of the instrument, or in any other way using any other asset either with or without a compensating payment either way, acceptable to the owner. This enables a person who already holds a physical asset, and pays storage and other costs associated with ownership and possession of the asset (collectively “associated costs”), to swap it into the mineral which is the subject of the Instrument and thereby acquire the rights to own that mineral on maturity, or to sell those rights prior to maturity, all without paying storage or other associated costs.

Alternatively, the purchaser could enter into a customised arrangement with the owner to exchange an existing Instrument indicating holdings of a mineral or other asset for the rights set out in this document.

In any event, in order for the purchaser to be willing to purchase the mineral, the owner that owns the right to extract and sell the mineral must typically be a credit-worthy entity likely to be in existence at the future specified time, and with reserves of the mineral which significantly exceed the quantity which is to be sold. However credit-worthiness is not an essential component, nor is it essential for it to be likely that the entity will be in existence at the future specified time, and nor is it essential for the owner to have reserves of the mineral which significantly exceed the quantity which is to be sold. All these factors can be overcome by the design of the sale transaction, and in the case of the reserves may not apply to all owners.

After purchase has occurred, an issuing module 20 issues the purchaser with a unique electronic certificate including at least the value, quantity of mineral, the specifications which the gold must meet and the future specified time.

The unique electronic certificate is an Instrument or account or record, in any form, that embodies, by reference or otherwise, an agreement from the owner that owns the rights to mine the gold ore, to sell to the purchaser the ounce of gold, to refine it to agreed specifications, to be delivered at the specified time.

The instrument is a tradable Instrument which the purchaser can sell to a third party for an agreed price. The third party will now have the right to the ounce of gold once it is mined and processed, and to oblige the miner to extract and refine and deliver it.

The Instrument is a fully paid up (in a spot sale context), tradeable and listable (on a registered Stock Exchange) Bill of Sale for a stated quantity of the mineral, to stated specifications, which is awaiting delivery. ft may be tradeable on a Stock Exchange or in a secondary market or in the “Over-the-Counter” (“OTC”) investment market.

In this context, OTC means trading in unlisted Instruments taking place outside of any registered exchange.

The Instrument will typically be issued at a subscription price which is either at, or at a slight premium or discount to, the ruling spot market price at that time of that quantity, to those specifications, of the mineral which is the subject of the instrument.

The Instrument will upon trading acquire a spot market price.

It will be appreciated that since the subscription price is payment under a spot sale and not a loan, no interest is payable on it by the owner.

The Instrument will oblige the owner to own or control or have rights to control (all legally or de facto) extraction rights to the mineral reserves, to store the mineral, extract it prior to the agreed delivery date, process it as required, store it in refined form and deliver the stated quantity of it, to the stated specifications, to the instrument holder on the maturity of the Instrument.

Price risk on the spot price of the mineral will pass to the holder of the Instrument from the issue date or a different date selected by the owner or agreed between the owner and the initial Instrument holder and will pass to each subsequent holder upon registration of transfer of the Instrument to such subsequent holder.

On redemption the instrument holder will take physical delivery of the mineral, failing which the owner will sell it on behalf of the Instrument holder on the open market taking commercially reasonable steps to maximise the price attained, and deliver the net of reasonable costs proceeds of the sale of the mineral to the Instrument holder. Other delivery methods could be arranged.

In the present example, the delivery will take place either in a place governed by the London Bullion Market Association Good Delivery Rules or in a place which has substantially the same Rules in force. It will be appreciated that any suitable pre-agreed rules could be used.

If the Instrument holder does not take transfer of the mineral at maturity of the Instrument, or arrange for the owner to buy or sell it, ownership in and risk of the mineral will pass to the Instrument holder on maturity.

The owner is then obliged to sell the mineral on the open market taking commercially reasonable steps to maximise the price attained. The owner will then pay the proceeds, net of the costs of and incidental to the sale and default process, to the Instrument holder.

The method further includes using the spot price, the quantity of mineral, the cost of extraction and the plurality of unique electronic certificates to assign a value to a body of mineral reserves currently in or on the Earth's crust.

This is carried out using the market value of the quantity of mineral determined by the spot price, the selected cost of extraction, and the size of the body of mineral reserves to assign a value to a body of mineral reserves.

However, this can only effectively be done based upon the issue of the plurality of unique electronic certificates which in essence prove the value of the mineral reserve in or on the Earth's crust.

An owner of a mineral reserve currently stored in its natural environment may use information on an Instrument or plurality of Instruments issued by another owner or plurality of owners of the same or a different mineral, which would typically include the spot price, and the stated quantity of the mineral, to stated specifications, which is awaiting delivery for that Instrument or Instruments and use the fact of the issue of that other Instrument, or plurality of Instruments, to assign a value, (using the spot price for his mineral and the extraction costs applicable to his mineral reserve) to a body of mineral reserve, owned by that owner, which is currently stored in or on the Earth's crust.

Thus it will be appreciated that the method described above is a method of mineral reserve utilisation which will enable the owner of the mineral reserve to sell pre-existing fungible minerals in or on the Earth's crust which form part of the mineral reserve, while assuming the obligation to extract such fungible commodities. This method of reserve utilisation once used by any owner of a mineral reserve will establish a standard which can be used by the issuing owner or any other owner of a reserve of the same or any other mineral to assign a value to a body of mineral reserve currently stored in or on the Earth's crust. Jr) the absence of establishing such a standard this valuation will not be possible.

The methodology described herein has a number of advantages.

It enables the recognition that mineral reserves are tangible and not intangible, and have, at any time, a current market value which can be calculated in terms of the described method and independently verified by reference to largely objective factors.

The establishment of a market trading in the mineral content of reserves utilising the Instruments will demonstrate that mineral reserves are tangible assets and will prove that mineral reserves should be treated as tangible assets in the financial statements of owners of mineral reserves.

The effect of converting financial statements to this true value mineral reserve valuation method will be a) to revalue the total mineral reserve held by the owner to be a tangible asset; b) to move mineral reserves from intangible off balance sheet assets to tangible on balance sheet assets at a commercial value; and c) to achieve a noticeable to significant increase in the tangible assets and capital of the owner.

This will in turn allow owners of mineral reserves to significantly strengthen their credit-worthiness, credit ratings and ability to borrow finance, by recognising that their mineral reserves have, at any time, a current market value which can be calculated and attained.

It will be appreciated that the owner will be exposed to the opportunity cost or benefit equal to the difference between the issue price of the Instrument and the spot price of the stated quantity, to the stated specifications, of the mineral reserve at the maturity date of the Instrument. The Instrument will typically be issued for periods long enough to allow the opportunity benefit of not paying interest on the subscription price to compound to such an extent as to mitigate or exceed any opportunity cost associated with the spot price risk on the mineral.

In order to track the financial benefits of the Instrument to the owner as a component of the method, the owner may maintain a notional sinking fund to which will be credited all subscription prices received plus appropriate compound interest which the owner would have had to pay had it borrowed the subscription price at the date it received it, and to which will be debited the cost of redemption.

It will also be appreciated that the owner obtains the benefit of having sold part of its mineral reserves before they are extracted, thereby receiving money up front for the sale, and obtaining interest-free funding without diluting its equity or increasing liabilities beyond the obligation to extract the mineral reserve.

The owner additionally obtains access to a different source of funding, from investors rather than lenders, on a different basis to that applied by lenders, and reduces its exposure to lenders, thereby creating capacity for additional borrowings from them,

It will also be appreciated that the holder of the Instrument acquires the right to the stated quantity of the mineral, on a basis which (a) protects him from having to pay storage and other associated costs, such as insurance, of the mineral: (b) allows him to trade his Instrument at any time, thereby turning it into money, at or close to the then current spot market price of the mineral itself; (c) allows him either to take delivery of the physical mineral on maturity of the Instrument, or to cash in the Instrument at that date; and (d) allows him to roll his investment over into a new tranche of the Instrument if he wishes and a new tranche is on offer.

It also be appreciated that the holder of the Instrument does not incur storage costs as the owner carries all costs, including storage costs (if any) prior to delivery.

It will also be appreciated that the creation of Instruments denominated in singularly defined commodities will satisfy a specific need from investors to be exposed to price risk in that specific mineral, an effect often difficult to achieve through holding shares in companies or in any other way.

The Instruments recognise that mineral reserves are tangible and have a realizable commercial value which can be independently verified by reference to largely objective factors.

The successful establishment of market trading in the mineral content of reserves utilising the Instruments in this application will also demonstrate that mineral reserves are tangible assets and will prove that mineral reserves should be treated as tangible assets in the financial statements of owners of mineral reserves who adopt the true value mineral reserve valuation method as has been described, The effect of converting financial statements to the method will be a) to revalue the total mineral reserve held by the owner by utilising the true value mineral reserve valuation method, treating the mineral reserve as a tangible asset; b) to demonstrate that mineral reserves should be moved from intangible off-balance sheet assets to tangible on-balance sheet assets with a commercially realizable value; and c) to achieve a noticeable to significant increase in the tangible assets and capital of the owner.

1. A system for implementing an electronic mineral reserve valuation, the system including:
a communications module for receiving an electronic request message from a purchaser to purchase a quantity of mineral, at a current spot price for the mineral, the quantity of mineral being currently stored in its natural environment in or on the Earth's crust and prior to it being extracted, the quantity of mineral, to agreed specifications, to be made available to the purchaser at a future specified time;
a memory for storing the identity of the purchaser, the price, the quantity of mineral, the agreed specifications and the future specified time; and
an issuing module for issuing the purchaser with a unique electronic certificate including at least the quantity of mineral, the agreed specifications and the future specified time.

2. A system according to claim 1 wherein the communications module receives requests from a plurality of users and issues unique electronic certificates to each of the plurality of users.

3. A system according to claim 1 further including a value allocating module for allocating a value to a quantity of mineral that is not yet extracted and storing the allocated value and quantity of mineral in a memory, wherein the value allocating module uses a current spot price for the mineral together with a selected extraction cost to allocate a value for the electronic certificates and to thereby assign a value to a body of mineral reserves currently stored in its natural environment in or on the crust of the Earth.

4. A system according to claim 3 wherein the value allocating module draws or accept inputs of the selected extraction cost from a miner's own calculations, current at the time that the value of the reserves is being calculated, of the cost of extracting various portions of the reserve, depending on the ore concentrations, accessibility and other relevant factors relating to the portion.

5. A system according to claim 4 wherein the value allocating module selects the extraction cost and a desired profit, that together do not exceed the spot price.

6. An electronic mineral reserve valuation method, the method including:
receiving an electronic request message from a purchaser to purchase a quantity of mineral, to stated specifications, at or slightly above or below, the current spot price for the mineral, the quantity of mineral being currently stored in its natural environment, in or on the crust of the Earth, the quantity of mineral to be made available to the purchaser at a future specified time;
storing the identity of the purchaser, the price, the quantity of mineral, the specifications and the future specified time; and
issuing the purchaser with a unique electronic certificate including at least the quantity of mineral, the specifications and the future specified time.

7. A method according to claim 6 wherein requests are received from a plurality of users and unique electronic certificates are issued to each of the plurality of users.

8. A method according to claim 6 further including allocating a value to a quantity of mineral that is not yet extracted, and storing the allocated value and quantity of mineral in a memory, wherein a current spot price for the mineral is used together with a selected extraction cost to allocate a value for the electronic certificates and to thereby assign a value to a body of mineral reserves currently stored in its natural environment.

9. A method according to claim 8 wherein the selected extraction cost is drawn from a miner's own calculations, current at the time that the value of the reserves is being calculated, of the cost of extracting various portions of the reserve, depending on the ore concentrations, accessibility and other relevant factors relating to the portion.

10. A method according to claim 9 wherein the extraction cost, plus a desired profit, is selected so that it does not exceed the spot price.
